(19) United States
(12) Patent Application Publication
(10) Pub. No.: US 2004/0024515 A1
(43) Pub. Date: Feb. 5, 2004

(54) Method and apparatus for limiting speed of air suspended vehicles

(76) Inventors: David Keith Troupe, Fogelsville, PA (US); Peter Gross, Coopersburg, PA (US)

Correspondence Address: ROTHWELL, FIGG, ERNST & MANBECK, P.C., 1425 K STREET, N.W., SUITE 800, WASHINGTON, DC, 20005, US

(21) Appl. No.: 10/209,939

(22) Filed: Aug. 2, 2002

(51) Int. Cl. B60K 31/00

(52) U.S. Cl. 701/93; 180/170; 123/351

(57) ABSTRACT

A vehicle speed reducing system for limiting the speed of a vehicle is provided. The vehicle speed reducing system includes a detector unit for determining a suspension status and a road speed of a vehicle, and outputting a suspension status signal and a vehicle speed signal. A vehicle control device determines whether the vehicle is driven at a non-standard ride height (i.e., air suspended) and exceeds a predetermined maximum speed limit based on the suspension status signal and the vehicle speed signal, respectively. An engine control device limits the speed of the vehicle to a predetermined minimum speed limit if it is determined that the vehicle is driven at the non-standard ride height and exceeds the predetermined maximum speed limit. Since the air suspended vehicle is limited to a minimum speed limit, damage to the vehicle's components is prevented.

### BACKGROUND OF THE INVENTION

1. Field of the Invention

The present invention relates generally to a road speed suspension interlock. Specifically, the invention relates to a method and an apparatus for limiting the speed of air suspended vehicles.

The term “vehicle” may include tractor trailers, load carrying vehicles, load carrying vehicles incorporating air suspension systems, cargo vehicles, vehicles equipped with an air actuated fifth wheel slide release, or the like.

2. Description of the Background Art

Air suspension systems for larger vehicles usually include one or more air springs at each end of each axle where the chassis, body and load (i.e., sprung mass) of the vehicle is supported on the wheels, suspension and axles (i.e., unsprung mass) of the vehicle. Generally, the source of air pressure is the air brake system of the vehicle. It is well known to allow for selective inflation or deflation of air springs or air bags for raising and lowering the rear cargo area of the vehicle to accommodate loading and/or unloading. This can be performed using a remote control unit that allows the operator of the vehicle to raise or lower the suspension within preset upper and lower stop limits. Alternatively, two different vehicle heights may be programmed.

The height of a vehicle platform may be maintained by an air suspension control valve. The height can be adjusted by an operator by overriding the air suspension control valve using an air ride suspension control switch, such as, for example, Mack Trucks, Inc. “V-MAC III”. The control switch activates the air suspension control valve, which deflates the air bags of the vehicle. Accordingly, the air suspension of the vehicle is depressurized.

The operator may inadvertently operate the vehicle while the air suspension is depressurized. In other words, the vehicle may be operated at a non-standard ride height (i.e., the vehicle is driven while the rear cargo area is lowered or raised). When the vehicle is driven continuously in this condition and at normal road speeds, the drive line angles are changed and premature wear and tear on various drive line components occur. The drive line components may include universal joints, carrier bearings, synchronizers and bearings in transmission, other transmission components, carrier pinion seals, axle housings, or the like. The suspension system and/or the shock absorbers may also be damaged.

Adjusting the height of air suspended vehicles has already been done, for example, in U.S. Pat. No. 5,273,308 to Griffiths. The height of the vehicle is adjusted using a height control valve (controlled by a selector valve) to raise or lower the vehicle. If an operator omits to return the selector valve to its normal condition before moving the vehicle, the selector valve is reverted to its normal condition by a pilot line connected to a service brake line. Accordingly, the vehicle automatically returns to its normal ride height on the first brake application or when the brake is applied.

U.S. Pat. No. 6,052,644 to Murakami et al. relates to an apparatus and method for limiting vehicle speed of a working vehicle. The purpose of limiting the speed is to provide a smooth traveling condition during vehicle speed limit and set a vehicle speed limit suitable for the environment. The system includes a vehicle speed detector for detecting a vehicle speed of the working vehicle to output a vehicle speed signal, and a vehicle speed control device connected to a depressing stroke detector, the vehicle speed detector and an engine control device. When the vehicle speed signal is smaller than a vehicle speed limit value and a corrected depressing stroke signal is larger than a depressing stroke signal, the depressing stroke signal is sent to an engine control device. Accordingly, the engine control device limits the speed of the vehicle.

Although the prior art discloses adjusting the height of air suspended vehicles and limiting the speed limit of a working vehicle, there is no method and/or apparatus for limiting the speed of a vehicle when the rear air suspension is at an evacuated air spring height, a low ride height, a high ride height, or the like. Accordingly, there remains a need in the art for a method and system for limiting the speed of air suspended vehicles.

### SUMMARY OF THE INVENTION

It is therefore an object of the present invention to provide a vehicle speed reducing system that prevents a vehicle from being driven at normal road speeds while the rear air suspension is at an evacuated air spring height, a low ride height, a high ride height, or the like.

It is a further object of the present invention to notify the operator of the vehicle that the vehicle is being operated at a non-standard ride height.

A vehicle speed reducing system for limiting the speed of a vehicle is provided according to a first aspect of the invention. The vehicle speed reducing system includes a detector unit for determining a suspension status and a road speed of a vehicle, and outputting a suspension status signal and a vehicle speed signal. A vehicle control device determines whether the vehicle is driven at a non-standard ride height and exceeds a predetermined maximum speed limit based on the suspension status signal and the vehicle speed signal, respectively. An engine control device limits the speed of the vehicle to a predetermined minimum speed limit if it is determined that the vehicle is driven at the non-standard ride height and exceeds the predetermined maximum speed limit.

A vehicle speed reducing system for limiting the speed of a vehicle is provided according to a second aspect of the invention. The vehicle speed reducing system includes an engine control device having a plurality of input pins and limiting the speed of the vehicle to a predetermined minimum speed limit.

A method of limiting the speed of a vehicle is provided according to a third aspect of the invention. The method comprises the steps of determining a suspension status of the vehicle, and determining a road speed of the vehicle. Also included is the step of limiting the speed of the vehicle to a predetermined minimum speed limit if it is determined that the vehicle is driven at a non-standard ride height and exceeds a predetermined maximum speed limit.

The above and other features and advantages of the present invention will be further understood from the following description of the preferred embodiment thereof, taken in conjunction with the accompanying drawings.

### BRIEF DESCRIPTION OF THE DRAWINGS

FIG. 1 is a general block diagram of a vehicle speed reducing apparatus according to a first embodiment of the present invention;

FIG. 2 is a specific block diagram of the vehicle speed reducing apparatus according to the first embodiment of the present invention;

FIG. 3 is a flowchart of a vehicle speed reducing method according to the present invention; and

FIG. 4 is a schematic of a vehicle speed reducing apparatus according to a second embodiment of the present invention.

### DETAILED DESCRIPTION OF THE PREFERRED EMBODIMENTS

Reference will now be made in detail to a preferred embodiment of the present invention, an example of which is illustrated in the accompanying drawings.

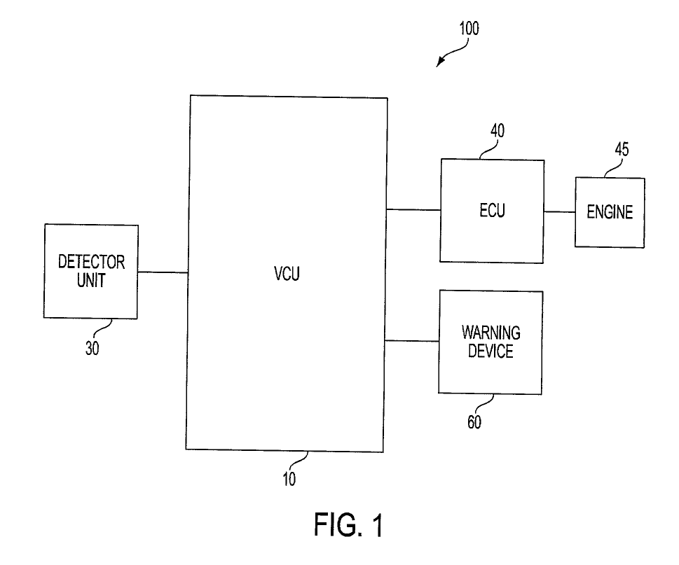

A vehicle speed reducing apparatus 100 according to the present invention is shown in FIG. 1. The vehicle speed reducing apparatus 100 may comprise a plurality of control units including, but not limited to, a vehicle control unit 10 and an engine control unit 40. The vehicle speed reducing apparatus 100 may also include a detector unit 30 and a warning device 60. A suspension status signal and a vehicle speed signal from the detector unit 30 are inputted to the vehicle control unit 10. The vehicle control unit 10 controls an engine 45 through an engine control unit 40.

The vehicle control unit 10 monitors the suspension status and the road speed of the vehicle, and determines if the suspension status and the road speed of the vehicle exceeds a predetermined maximum speed limit. The vehicle control unit 10 outputs throttle control messages to the engine control unit 40 when the vehicle is operated at a non-standard ride height (i.e., an evacuated air spring height, a low ride height, a high ride height, etc.) during normal road speeds in order to limit the speed of the vehicle to a predetermined minimum speed limit.

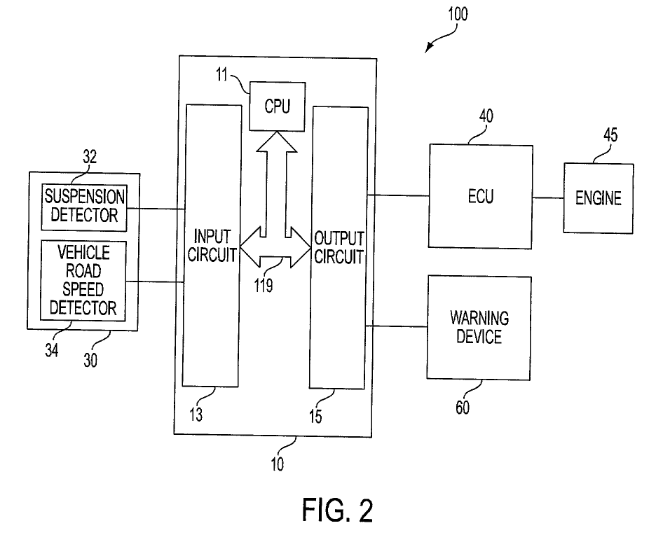

The detector unit 30, as shown in FIG. 2, is composed of an air suspension detector 32 and a vehicle road speed detector 34. Although the detector unit 30 is composed of the air suspension detector 32 and the vehicle road speed detector 34 in FIG. 2, it can be a single unit that detects both the suspension status of the vehicle and the road speed of the air-suspended vehicle.

The suspension status of the vehicle is determined by the suspension detector 32 of the detector unit 30, which can be electrically controlled. The suspension detector 32 determines whether the vehicle is operated at a non-standard ride height or not. Standard ride heights depend on the suspension of the vehicle. Standard ride height is the measurement of the axle center line to the bottom of the frame loaded. This dimension is specific to each suspension. Non-limiting examples of standard ride heights are within a range of 244-255 mm. Non-standard ride heights may include an evacuated air spring height, a low ride height, a high ride height, or the like. When the suspension detector 32 is activated, suspension status signals (i.e., indicating the suspension status of the vehicle) are inputted to the vehicle control unit 10. The suspension status signals are monitored by the vehicle control unit 10. Based on the suspension status signals, the vehicle control unit 10 can deliver throttle control messages to the engine 45 via the engine control unit 40 to limit the speed of the vehicle.

Suspension status is a functioning determination. The system which keeps the suspension at the standard ride height may be overridden by a request to lower or raise rear height of the truck. This can be accomplished by simply dumping or inflating the air springs with a valve controlled by a switch, or the air in the spring can be regulated by valves controlled by a suspension height sensing electronic control unit (ECU) which can adjust the pressure in the air spring to raise or lower the suspension to several predetermined ride heights which are not the standard height for the suspension. Suspension status can also be a non-functioning determination or fault status if the air springs have lost pressure due to a failure in the system's ability to provide and maintain air pressure in the air spring to keep it at standard height.

The road speed of a vehicle is determined by the vehicle road speed detector 34 of the detector unit 30. Typically, road speeds of a vehicle are between 0 and 130 miles per hour (mph), and normal road speeds are between 30 and 65 mph. Vehicle speed signals (e.g., indicating the speed of the vehicle) are then inputted to the vehicle control unit 10. The vehicle control unit 10 monitors the speed of the vehicle. If it is determined that the vehicle is being operated at a non-standard ride height and the vehicle is exceeding a predetermined maximum speed limit of approximately 25 mph, the vehicle control unit 10 sends throttle control messages to the engine 45 via the engine control unit 40 to limit the speed of the vehicle to a predetermined minimum speed limit of approximately 5 to 25 mph.

As shown in FIG. 1, the engine control unit 40 receives throttle control messages or signals from the vehicle control unit 10. The vehicle control unit 10 sends throttle control messages to the engine control unit 40 indicating that the vehicle is being operated at a non-standard height at normal road speeds of approximately 30 to 65 mph. The engine control unit 40 limits the revolutions per minute (rpm) and power of the engine 45 based on the throttle control messages. Accordingly, the engine output torque is limited when the vehicle exceeds the predetermined maximum speed limit and is operated at a non-standard ride height.

The warning device 60 inputs a warning signal from the vehicle control unit 10 and notifies the operator of the vehicle that the vehicle is being operated at a non-standard ride height, the vehicle speed is being limited, etc. The warning device 60 may include a buzzer sound, a warning lamp, a warning message (audio or visual), or the like. In addition, the warning device 60 may be located at a position where the operator of the vehicle can easily receive the warning while operating the vehicle.

FIG. 2 illustrates a specific block diagram of the vehicle speed reducing apparatus 100, which will now be described in detail. The detector unit 30 is composed of the air suspension detector 32 and the vehicle road speed detector 34. The air suspension detector 32 may be an air dump solenoid valve. When the air dump solenoid valve is energized, the suspension is evacuated. Accordingly, the solenoid input defines the status of the suspension of the vehicle. The air suspension detector 32 of the present invention is not limited to the above air dumped solenoid valve, and it will be appreciated that any means for detecting the suspension status of the vehicle may be implemented in the present invention.

A wheel speed sensor may be used as the vehicle road speed detector 34. The wheel speed sensor may be fixed to a shaft which is synchronized with the rotation shaft of the rear wheels of the vehicle. The wheel speed sensor outputs an output pulse, and the number of rotations per unit time of the rear wheels can be calculated to determine the vehicle road speed. A tail shaft speed sensor may also be used as the vehicle road speed detector 34. The tail shaft speed sensor can be connected to any of the control units on the vehicle, including, but not limited to, the vehicle control unit 10, a transmission control unit (not shown), or the engine control unit 40. The output of the tail shaft sensor may be a voltage pulse per gear tooth on the output shaft of the transmission. The control units can be programmed to determine the vehicle speed, for example, in pulses per mile. After the speed of the vehicle is determined, the vehicle speed signal (indicating the speed of the vehicle) is inputted to the vehicle control unit 10. The vehicle road speed detector 34 of the present invention is not limited to the above wheel speed or tail shaft sensors, and it will be appreciated that any means for detecting the vehicle road speed of the vehicle may be implemented in the present invention.

The vehicle control unit 10 is composed of a general microcomputer system. A CPU or microcomputer 11 may include a storage device/memory, a processor, an executing device, an input/output interface, etc. Data used to limit the speed of the vehicle to the predetermined minimum speed limit is stored in the memory of the CPU 11. An input circuit 13 communicates the suspension signals and the vehicle speed signals from the air suspension detector 32 and the vehicle road speed detector 34, respectively, to the CPU 11 through a data and control bus 11a. An output circuit 15 outputs the throttle control signals to the engine control unit 40 and delivers the warning signal to the warning device 60 from the CPU 11.

Further, the vehicle control unit 10 constantly monitors the incoming signals, compares the signals to predetermined nominal values stored in the memory, and determines the required controlling reaction if the actual value differs from the nominal value. The vehicle control unit 10 also monitors the function of all system components, and stores the information about any detected errors.

The engine control unit 40, which can be electronically controlled, receives throttle control messages from the vehicle control unit 10 if it is determined by the vehicle control unit 10 that the vehicle is being driven at normal road speeds while the rear air suspension is at an evacuated air spring height, a low ride height, a high ride height, or the like. The rpm and power of the engine 45, or the engine output torque is limited based on the received throttle control messages. In other words, the engine control unit 40 can regulate engine speed in the vehicle by broadcasting torque requests or throttle position signals.

More specifically, the engine control unit 40 controls the amount of fuel delivered to the combustion cylinders in the engine 45. The fuel injectors are electronically opened and closed. The engine control unit 40 provides the electronic signal to the fuel injectors to provide fuel to the engine cylinders of the engine 45. The amount of fuel provided to the engine 45 affects the engine output power and speed. Further, the engine control unit 40 controls the compression brake solenoids on the engine 45.

The warning device 60 can be composed of a warning buzzer and a lamp for notifying the operator of the vehicle that the vehicle is being operated at a non-standard ride height and/or the vehicle is being limited to the predetermined minimum speed limit. The warning device 60 may be complex if an audio signal is delivered to the operator. On the other hand, the warning device 60 may be simple if a text, character or graphic display is used for the warning device 60 or if the warning signal is effected by a serial communication.

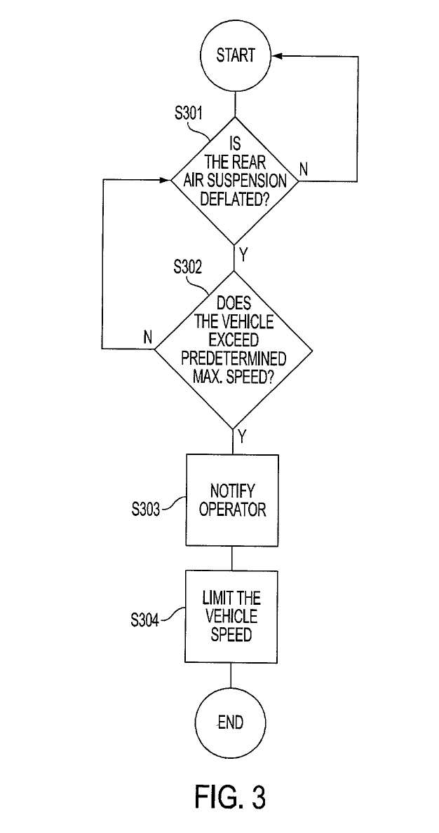

Next, the operation of the vehicle speed reducing system for limiting the speed of an air suspended vehicle according to the present invention will now be described with reference to FIG. 3.

In step S301, the suspension detector 32 determines the suspension status of the vehicle and outputs the suspension status signals to the vehicle control unit 10. If the rear air suspension of the vehicle is at an evacuated air spring height, a low ride height, a high ride height, or the like (i.e., a non-standard ride height), the road speed of the vehicle is determined by the vehicle road speed detector 34 in step S302. The vehicle road speed detector 34 outputs the vehicle speed signals to the vehicle control unit 10. The operator of the vehicle may be notified, in step S303, that the vehicle is being operated at a non-standard ride height, the vehicle speed is being limited, etc.

If the air suspended vehicle exceeds the predetermined maximum speed limit of approximately 25 mph, the vehicle speed is limited to approximately 0 to 25 mph in step S304. The vehicle control unit 10 sends throttle control messages to the engine control unit 40. The engine control unit 40 prevents the throttle control of the engine 45 to increase vehicle speed beyond the predetermined minimum speed limit. The engine control unit 40 limits the throttle or engages the engine retarding device (not shown) of the engine 45 in order to limit the vehicle road speed to the predetermined minimum speed limit.

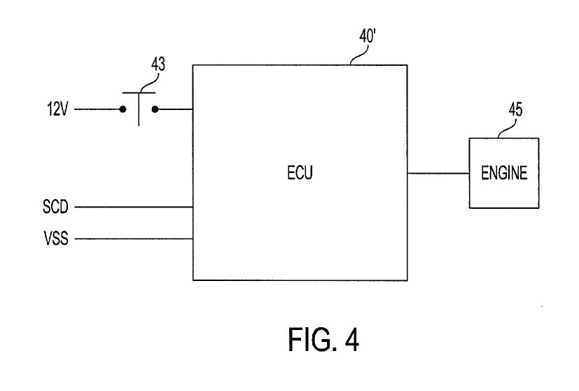

FIG. 4 is a block diagram of a vehicle speed reducing apparatus according to a second embodiment of the present invention. The vehicle speed reducing apparatus includes a programmable engine control unit 40′. The engine control unit 40′ may be used as a road speed interlock, and may be compatible with antilock braking systems (ABS), and automatic traction control (ATC) systems. Further, the engine control unit 40′ may be an engine ECU (electronic control unit), a vehicle ECU, an ABS ECU, a transmission ECU, a suspension ECU, or a combination thereof. Each can be connected by a data link, which is an electronic transfer of information, and can make requests for responses from the other units, e.g., engine speed or dash warnings and displays.

The vehicle ECU may monitor a number of inputs from sensors and switches, and drive a number of devices. The ABS ECU may monitor wheel speed from wheel speed sensors, and control ABS modulator valves and brake apply valves in order to regulate brake pressure on the wheels of the vehicle. The transmission ECU can control the transmission gear selection, and shift the transmission with solenoids. The suspension ECU can monitor vehicle suspension height through height sensors, control air to the suspension air springs through air solenoids, and monitor air pressure in the springs and in the air supply system.

The engine control unit 40′ may have several input pins or ports, some of which are unused. Connections can be made between an electrical equipment panel of the vehicle and the input pins of the engine control unit 40′. It will be appreciated that vehicles having various electrical equipment panels can be accommodated with the engine control unit 40′ of the present invention.

The road speed interlock prevents the vehicle from being driven at normal road speeds (approximately 30 to 65 mph) while the rear air suspension of the vehicle is at an evacuated air spring height, a low ride height, a high ride height, or the like. Referring to FIG. 5, a battery voltage is applied to one of the unused input pins of the engine control unit 40′. When the battery voltage is applied to the input pin, a logical input pin is activated.

Each time the battery voltage is applied to the input pin of the engine control unit 40′, a vehicle road speed limit of approximately 0 to 25 mph, which is predetermined, will be applied. Accordingly, a switch 43 must have continuity (i.e., a closed state) before the vehicle road speed limit is applied. Closed switches have continuity in their rest state. When a normally closed switch is activated, there is no continuity. On the other hand, an open switch does not have continuity in its rest state. When a normally open switch is activated, there is continuity.

The engine control unit 40′ may include at unused input pins suspension control data (scd) and vehicle speed sensor data (vss) for limiting the speed of the vehicle based on the suspension status and the vehicle speed of the vehicle, respectively. Other sensor inputs may include ABS status data or vehicle gear status data.

The engine control unit 40′ can monitor the sensor inputs and control fuel to the engine 45 based on the sensor inputs. The amount of fuel and the compression brake status can be determined by any of the inputs or combination of inputs depending on the parameters defined in the engine control unit 40′. The parameters can include present engine speed or torque levels, gear ranges and dash displays and warnings.

According to the present invention, when a vehicle is driven at a non-standard road height during normal road speeds, the vehicle speed is limited to a predetermined minimum speed limit, thereby eliminating the damage to the vehicle's components. Further, the operator of the vehicle is notified that the vehicle is being operated at a non-standard ride height and that the vehicle is being limited to the predetermined minimum speed limit.

While the invention has been described in detail above, the invention is not intended to be limited to the specific embodiments as described. It is evident that those skilled in the art may now make numerous uses and modifications of and departures from the specific embodiments described herein without departing from the inventive concepts. For example, the road speed interlock system is applicable to vehicles equipped with an air actuated fifth wheel slide release. In this manner, the road speed interlock system controls engine revolutions per minute and vehicle speed in order to prevent the possibility of damage to a vehicle and/or a trailer caused by accidental separation.

What is claimed is:

1. A vehicle speed reducing system for limiting speed of a vehicle, comprising:
a detector for determining a suspension status and a road speed of said vehicle, and outputting a suspension status signal and a vehicle speed signal;
a vehicle control device for determining whether said vehicle is driven at a non-standard ride height and exceeds a predetermined maximum speed limit based on said suspension status signal and said vehicle speed signal, respectively; and
an engine control device for limiting said speed of said vehicle to a predetermined minimum speed limit if it is determined that said vehicle is driven at said non-standard ride height and exceeds said predetermined maximum speed limit.

2. The vehicle speed reducing system of claim 1, further comprising a warning device.

3. The vehicle speed reducing system of claim 2, wherein said warning device comprises at least one of a buzzer sound, a warning lamp, an audio warning message, and a visual warning message.

4. The vehicle speed reducing system of claim 2, wherein said warning device notifies an operator of said vehicle that said vehicle is being operated at said non-standard ride height.

5. The vehicle speed reducing system of claim 2, wherein said warning device notifies an operator of said vehicle that said vehicle is being limited to said predetermined minimum speed limit.

6. The vehicle speed reducing system of claim 1, wherein said detector unit comprises an air suspension detector and a vehicle road speed detector.

7. The vehicle speed reducing system of claim 6, wherein said air suspension detector is an electronically controlled air dump solenoid valve.

8. The vehicle speed reducing system of claim 1, wherein said predetermined maximum speed limit is approximately 25 miles per hour.

9. The vehicle speed reducing system of claim 6, wherein said vehicle road speed detector is a wheel speed sensor.

10. The vehicle speed reducing system of claim 6, wherein said vehicle road speed detector is a tail shaft speed sensor.

11. The vehicle speed reducing system of claim 2, wherein said vehicle control device comprises:
a microprocessor for storing data used to limit said vehicle to said predetermined minimum speed limit;
an input circuit for communicating said suspension signal and said vehicle speed signal from said detector to said microprocessor through a data and control bus; and
an output circuit for outputting throttle control signals to said engine control device and delivering a warning signal to said warning device.

12. The vehicle speed reducing system of claim 11, wherein said engine control device limits revolutions per minute and power of an engine based on said throttle control signals.

13. The vehicle speed reducing system of claim 1, wherein said vehicle is at least one of a tractor trailer, a load carrying vehicle, a load carrying vehicle incorporating air suspension systems, and a cargo vehicle.

14. The vehicle speed reducing system of claim 1, wherein said vehicle is equipped with an air actuated fifth wheel slide release.

15. A vehicle speed reducing system for limiting the speed of a vehicle, comprising:
an engine control device having a plurality of input pins and limiting said speed of said vehicle to a predetermined minimum speed limit.

16. The vehicle speed reducing system of claim 15, wherein a vehicle speed limit is applied when a battery voltage is applied to said one of said input pins.

17. The vehicle speed reducing system of claim 15, further comprising, at said input pins, suspension control data for determining and setting suspension status, and a vehicle speed sensor for determining and setting vehicle speed of said vehicle.

18. The vehicle speed reducing system of claim 17, wherein said vehicle is limited based on said suspension status and said vehicle speed of said vehicle

19. A method of limiting the speed of a vehicle, comprising the steps of:
determining a suspension status of said vehicle;
determining a road speed of said vehicle; and
limiting said speed of said vehicle to a predetermined minimum speed limit if it is determined that said vehicle is driven at a non-standard ride height and exceeds a predetermined maximum speed limit.

20. The method of claim 19, wherein an operator of said vehicle is notified that said vehicle is being operated at said non-standard ride height.

21. The method of claim 19, wherein an operator of said vehicle is notified that said vehicle is being limited to said predetermined minimum speed limit.

22. The method of claim 19, wherein said vehicle is at least one of a tractor trailer, a load carrying vehicle, a load carrying vehicle incorporating air suspension systems, and a cargo vehicle.

23. The method of claim 19, wherein said vehicle is equipped with an air actuated fifth wheel slide release.

24. The vehicle speed reducing system of claim 1, wherein said predetermined minimum speed limit is in a range from 0 to 25 miles per hour.

25. The vehicle speed reducing system of claim 15, wherein said predetermined minimum speed limit is in a range from 0 to 25 miles per hour.

26. The method of claim 19, wherein said predetermined maximum speed limit is approximately 25 miles per hour.

27. The method of claim 19, wherein said predetermined minimum speed limit is in a range from 0 to 25 miles per hour.

28. The vehicle speed reducing system of claim 15, wherein said engine control device includes an engine (electronic control unit) ECU, a vehicle ECU, an ABS ECU, a transmission ECU, a suspension ECU, or a combination thereof.
